(19) United States
(12) Patent Application Publication
(10) Pub. No.: US 2013/0008417 A1
(43) Pub. Date: Jan. 10, 2013

(54) Control system for engine with exhaust gas recirculation

(75) Inventors: Rammohan Sankar, Dunlap, IL (US); Ben Nash, Peoria, IL (US); Keith Troisi, Washington, IL (US); Travis Barnes, Metamora, IL (US); Christopher Smith, Washington, IL (US); Gregory Armstrong, Edwards, IL (US); Adwait Joshi, Dunlap, IL (US); Aaron Luft, Frankfort, IN (US)

(73) Assignee: CATERPILLAR INC., Peoria, IL (US)

(21) Appl. No.: 13/177,264

(22) Filed: Jul. 6, 2011

(51) Int. Cl. F02M 25/07; F02B 37/00; F02B 47/08

(52) U.S. Cl. 123/568.12; 123/568.16; 60/605.2

(57) ABSTRACT

An internal combustion engine includes an exhaust restriction valve and an exhaust gas recirculation control valve. Upon determining that a malfunction or fault condition exists relative to one of the valves, the controller may command the other valve to move towards a predetermined position. A malfunction or fault condition may result in derating of the engine.

### TECHNICAL FIELD

This disclosure relates generally to a control system for use with an internal combustion engine having an exhaust gas recirculation system and, more particularly, to a control system for controlling engine operating conditions based upon certain fault conditions.

### BACKGROUND

An exhaust gas recirculation system may be used to reduce the generation of undesirable pollutant gases during the operation of internal combustion engines. Exhaust gas recirculation systems generally recirculate exhaust gas generated during the combustion process into the intake air supply of the internal combustion engine. The exhaust gas introduced into the engine cylinders displaces a volume of the intake air supply that would otherwise be available for oxygen. Reduced oxygen concentrations lower the maximum combustion temperatures within the cylinders and slow the chemical reactions of the combustion process, which decreases the formation of oxides of nitrogen (NOₓ).

Many internal combustion engines having such an exhaust gas recirculation system also have an exhaust gas recirculation control valve and some further include an exhaust restriction valve. The exhaust gas recirculation valve is typically used to control the flow of exhaust gas through the exhaust gas recirculation system while the exhaust restriction valve is typically used to control the flow of exhaust gas through the exhaust gas system.

U.S. Pat. No. 6,453,734 discloses a diagnostic technique for use with an internal combustion engine having an exhaust gas recirculation system. Upon determining that an abnormal condition within the exhaust gas recirculation system has occurred, the exhaust gas recirculation system utilizes a two-stage process to evaluate system performance. If the diagnostic system determines that there is an abnormal condition, the exhaust gas recirculation system is turned off.

### SUMMARY

An internal combustion engine having an exhaust gas recirculation system is provided. In one aspect, an internal combustion engine has a plurality of combustion cylinders and an exhaust gas system fluidly connected to the plurality of combustion cylinders. An intake air system supplies air to the combustion cylinders. The exhaust gas system includes an exhaust manifold, an exhaust gas outlet, and an exhaust restriction valve for controlling flow of exhaust gas from the exhaust manifold to the exhaust gas outlet. An exhaust gas recirculation system recirculates exhaust gas from the exhaust gas system to the intake air system. The exhaust gas recirculation system includes an exhaust gas recirculation control valve for controlling flow of exhaust gas to the intake air system. A controller is provided that is configured to receive an exhaust restriction valve fault signal indicative of a fault of the exhaust restriction valve and transmit a signal directing the exhaust gas recirculation control valve to move towards a closed position in response to the fault signal.

In another aspect, the controller is configured to receive an exhaust gas recirculation control valve fault signal indicative of a fault of the exhaust gas recirculation control valve and transmit a signal directing the exhaust restriction valve to move towards an open position in response to the signal.

In a further aspect, a method is provided for controlling valve positioning in an internal combustion engine having a exhaust restriction valve for selectively restricting engine exhaust exiting from combustion cylinders and an exhaust gas recirculation control valve for restricting the output of an exhaust gas recirculation system. The method includes receiving a fault signal indicative of a fault of a first valve of the exhaust restriction valve and the exhaust gas recirculation control valve, and transmitting a signal directing a second valve of the exhaust restriction valve and the exhaust gas recirculation control valve to a predetermined position in response to receipt of the fault signal.

### BRIEF DESCRIPTION OF THE DRAWINGS

FIG. 1 is a schematic illustration of an internal combustion engine in accordance with the disclosure;

FIG. 2 is a block diagram illustrating various connections between a controller and various components of the internal combustion engine of FIG. 1;

FIG. 3 is a flowchart illustrating a fault control process to be executed by the controller of FIG. 2 upon the occurrence of a fault of the exhaust restriction valve;

FIG. 4 is a flowchart illustrating a further aspect of the fault control process of FIG. 3;

FIG. 5 is a flowchart illustrating a fault control process to be executed by the controller of FIG. 2 upon the occurrence of a fault of the wastegate valve;

FIG. 6 is a flowchart illustrating a further aspect of the fault control process of FIG. 5;

FIG. 7 is a flowchart illustrating a fault control process to be executed by the controller of FIG. 2 upon the occurrence of a fault of the compressor bypass valve; and

FIG. 8 is a flowchart illustrating a further aspect of the fault control process of FIG. 7.

### DETAILED DESCRIPTION

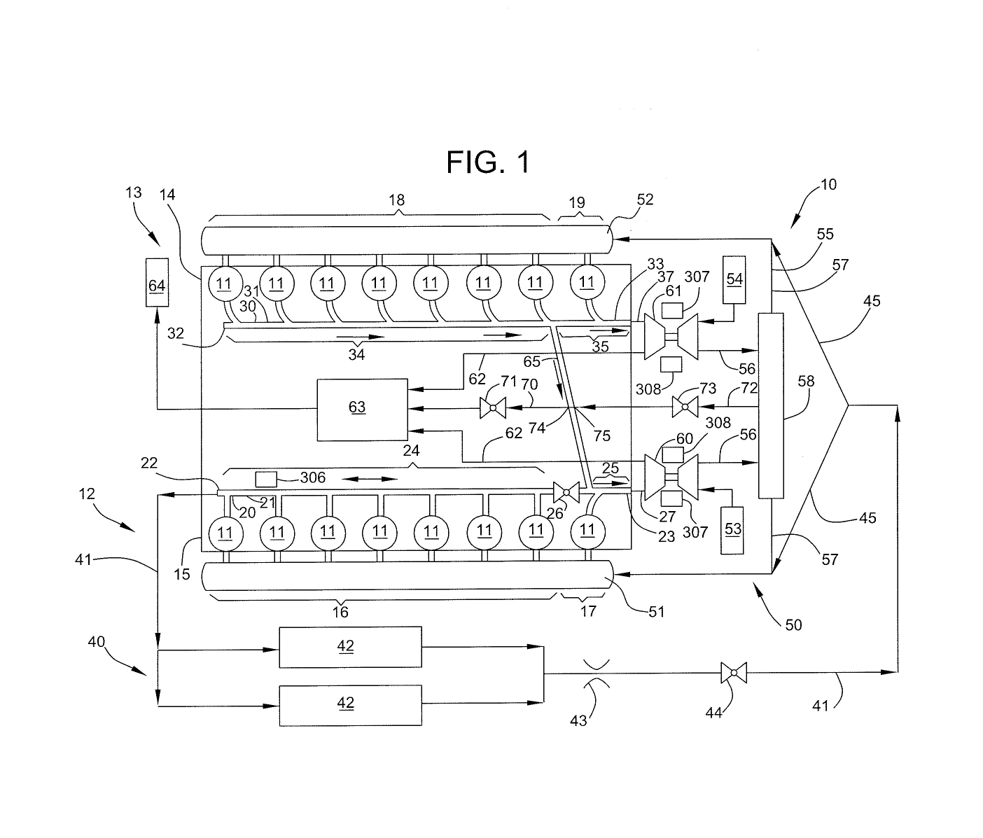

FIG. 1 depicts an internal combustion engine 10 having a plurality of combustion cylinders 11 configured as a first cylinder bank 12 and a second cylinder bank 13 generally parallel to the first cylinder bank. An exhaust gas system 28 includes a first exhaust gas line 20 and a second exhaust gas line 30. The first exhaust gas line 20 is fluidly connected to the first cylinder bank 12 and the second exhaust gas line 30 is fluidly connected to the second cylinder bank 13. Compressed air is supplied to the first and second cylinder banks 12, 13 by intake air system 50. The exhaust gas recirculation system 40 provides for the recirculation of exhaust gas into the intake air system 50 to reduce the emissions of the internal combustion engine 10.

A first cylinder head 14 is secured to the internal combustion engine 10 adjacent the first cylinder bank 12 and a second cylinder head 15 is secured to the internal combustion engine adjacent the second cylinder bank 13 of combustion cylinders. The first cylinder bank 12 includes a first cylinder group 16 and a second cylinder group 17. The second cylinder bank 13 includes a first cylinder group 18 and a second cylinder group 19. While the first cylinder group 16 of first cylinder bank 12 and the first cylinder group 18 of the second cylinder bank 13 are each depicted with seven combustion cylinders 11 and the second cylinder group 17 of the first cylinder bank 12 and the second cylinder group 19 of the second cylinder bank 13 are each depicted with one combustion cylinder 11, the combustion cylinders of each cylinder bank may be grouped as desired to define or form cylinder groups having different numbers of combustion cylinders.

First exhaust gas line 20 includes a first exhaust manifold 21 that is fluidly connected to the first cylinder bank 12. First exhaust manifold 21 has a first end 22 and an opposite exhaust end 23 with a first section 24 and a second section 25 between the two ends. An exhaust restriction valve 26 is positioned between the first section 24 and the second section 25. A first extension pipe 27 extends between the exhaust end 23 of first exhaust manifold 21 and first turbocharger 60 and fluidly connects the first exhaust manifold to the first turbocharger. As a result, exhaust restriction valve 26 is positioned upstream of first turbocharger 60.

Second exhaust gas line 30 includes a second exhaust manifold 31 that is fluidly connected to the second cylinder bank 13. The second exhaust manifold 31 may be generally parallel to the first exhaust manifold and has a first end 32 and an opposite exhaust end 33 with a first section 34 and a second section 35 between the two ends. A second extension pipe 37 extends between the exhaust end 33 of the second exhaust manifold 31 and second turbocharger 61 and fluidly connects the second exhaust manifold to the second turbocharger.

Exhaust gas from the first cylinder group 16 of the first cylinder bank 12 is received within the first section 24 of the first exhaust manifold 21 and, depending upon the positions of exhaust restriction valve 26 and exhaust gas recirculation valve 44, may be routed through the exhaust gas recirculation system 40. The exhaust gas recirculation system 40 may include an exhaust gas recirculation duct 41 that is fluidly connected to the first end 22 of the first exhaust gas line 20 so that exhaust gas from the first cylinder group 16 of the first cylinder bank 12 may be routed or recirculated through the exhaust gas recirculation system and introduced into the intake air system 50.

Exhaust gas passing through exhaust gas recirculation duct 41 may be cooled by one or more exhaust gas recirculation cooling components 42. The flow rate through exhaust gas recirculation duct 41 may be monitored by a flow meter 43 such as a venturi-style flow meter. An exhaust gas recirculation control valve 44 may be provided along exhaust gas recirculation duct 41 downstream of the exhaust gas recirculation cooling components 42 to control exhaust gas flow through the exhaust gas recirculation system 40. Exhaust gas recirculation control valve 44 together with exhaust restriction valve 26 control the amount of exhaust gas that is mixed with air that has been compressed by the first turbocharger 60 and the second turbocharger 61 prior to the air entering the first intake manifold 51 and the second intake manifold 52. The exhaust gas recirculation duct 41 of the exhaust gas recirculation system may 40 split into two separate legs 45. Each leg 45 fluidly connects to the intake air system 50 between the aftercooler 58 and the first intake manifold 51 and the second intake manifold 52, respectively.

Intake air system 50 includes a first air intake 53 through which atmospheric air enters the first turbocharger 60, a second air intake 54 through which atmospheric air enters the second turbocharger 61 and a compressed air line 55 through which compressed air is supplied to combustion cylinders 11. More specifically, atmospheric air is compressed by the first and second turbochargers 60, 61 and passes through first compressed air lines 56 to aftercooler 58. Cooled compressed air exits the aftercooler 58 and enters second compressed air lines 57 that are each fluidly connected to a respective one of the first and second intake manifolds 51, 52. Each leg 45 of the exhaust gas recirculation system 40 intersects with and fluidly connects to a respective one of the second compressed air lines 57 between the aftercooler 58 and the first and second intake manifolds 51, 52. In this way, exhaust gas may be mixed with intake air provided to the combustion cylinders 11.

A portion of exhaust gas from the first cylinder group 16 of the first cylinder bank 12 is, at times, routed through the exhaust gas recirculation system 40 rather than through the first exhaust gas line 20. For this reason, a duct or exhaust gas balance tube 65 may be fluidly connected between the first exhaust gas line 20 and the second exhaust gas line 30 to balance or equalize, to a controllable extent, the amount of exhaust gas passing through the first and second turbochargers 60, 61. In other words, the exhaust gas balance tube 65 provides a path for exhaust gas to travel from second exhaust gas line 30 towards first exhaust gas line 20 to balance the flow through the first and second turbochargers 60, 61.

After the exhaust gas from the first cylinder bank 12 and second cylinder bank 13 passes through the first and second turbochargers 60, 61, respectively, it exits the turbochargers through turbocharger exhaust gas lines 62. Turbocharger exhaust gas lines 62 may be fluidly connected to an exhaust aftertreament system 63 such as a diesel particulate filter so that the exhaust gas is filtered prior to being discharged or released to the atmosphere through exhaust gas outlet 64. It should be noted that although the internal combustion engine 10 depicted in FIG. 1 includes two cylinder banks, certain aspects of the disclosure may also be used with internal combustion engines having only a single, in-line bank of combustion cylinders.

Under certain operating conditions, it may be desirable to reduce the shaft speed of the first and second turbochargers 60, 61 so that the turbochargers may be maintained within a desired operating range. In order to do so, the amount of exhaust gas passing through the first and second exhaust gas lines 20, 30 may be reduced by venting or releasing a desired amount of exhaust gas from the exhaust gas lines. Such exhaust gas may be released in a relatively consistent manner from both the first and second exhaust gas lines 20, 30 by utilizing a wastegate 70 that is fluidly connected at wastegate interconnection 74 to exhaust gas balance tube 65 to permit exhaust gas to be released from the wastegate. A wastegate valve 71 controls or regulates the flow of exhaust gas through wastegate 70.

Under certain other operating conditions, it may be desirable to reduce the pressure within the compressed air line 55. In such case, a compressor bypass 72 and its associated compressor bypass valve 73 may be used to control or regulate the venting or release of compressed air from the compressed air line 55. The compressor bypass 72 may fluidly connect the compressed air line 55 adjacent aftercooler 58 with the exhaust gas balance tube 65 at compressor bypass interconnection 75.

Each of the exhaust restriction valve 26, the exhaust gas recirculation control valve 44, the wastegate valve 71 and the compressor bypass valve 73 may be configured to operate at all positions between an open position and a closed position. An actuator (not shown) may be connected to each valve to control the position of the valve. The actuator may be controlled and driven by any means including electrical, gear, lever, hydraulic or pneumatic. In one configuration, the actuator of each valve must determine the position of its respective valve as well as the open end stop or limit position and the closed end stop or limit position. Each valve may have a default position at which it is desirable for the valve to be positioned at start-up and other operating conditions. In one configuration, the exhaust restriction valve 26 may have a default position that is fully open while each of the exhaust gas recirculation control valve 44, the wastegate valve 71, and the compressor bypass valve 73 may have a default position that is fully closed. In other instances, the default position may be a desired, predetermined position.

During operation, exhaust gas exits or flows from the first cylinder bank 12 and enters first exhaust manifold 21. The flow of exhaust gas from the first cylinder group 16 towards first turbocharger 60 and through exhaust gas recirculation system 40 is controlled by the position of exhaust restriction valve 26 and by the position of exhaust gas recirculation control valve 44. At start up and some idle conditions, the exhaust gas recirculation control valve 44 may be completely closed. Also in such operating conditions, the exhaust restriction valve 26 may be completely open such that exhaust gas from the first cylinder bank 12 travels through first exhaust manifold 21 and first extension pipe 27 into first turbocharger 60. Exhaust gas from the second cylinder bank 13 travels through the second exhaust manifold 31 and second extension pipe 37 into second turbocharger 61. Since no exhaust gas is being recirculated through the exhaust gas recirculation system 40, exhaust gas from the first cylinder bank 12 is entirely directed towards the first turbocharger 60. Thus, the pressure within the first and second manifolds 21, 31 will be generally equal and little, if any, exhaust gas will travel through the exhaust gas balance tube 65 from the second exhaust manifold 31 to the first exhaust manifold 21.

As engine speed and load increase, it may be desirable to increase the amount of exhaust gas being recirculated or diverted through the exhaust gas recirculation system 40. In doing so, exhaust gas recirculation control valve 44 is utilized to initially control the flow through the exhaust gas recirculation system 40. Once the exhaust gas recirculation control valve 44 is fully open, further increases in the amount of recirculated exhaust gas can be accomplished by gradually closing the exhaust restriction valve 26.

As more exhaust gas is recirculated through exhaust gas recirculation system 40, less exhaust gas from the first cylinder group 16 of first cylinder bank 12 may pass through first exhaust manifold 21 into first turbocharger 60. The reduction in exhaust gas flow within the first cylinder bank may result in a pressure differential between the first exhaust manifold 21 and the second exhaust manifold 31. As a result of greater pressure within second exhaust manifold 31 due to the recirculation of some of the exhaust gas from the first cylinder bank, exhaust gas in the second cylinder bank 13 may pass from second exhaust manifold 31 through exhaust gas balance tube 65 into first exhaust manifold 21 to balance the flow through the first and second exhaust manifolds.

Rotation of the first turbocharger 60 compresses air drawn in through the first air intake 53 and rotation of second turbocharger 61 compresses air drawn in through the second air intake 54. The compressed air is routed through first compressed air line 56 and through aftercooler 58. After exiting aftercooler 58, compressed intake air is mixed with exhaust gas flowing through the exhaust gas recirculation system 40. The combined compressed air and recirculated exhaust gas passes through the compressed air line 55 into the first intake manifold 51 and the second intake manifold 52.

When the rotational speed of the shafts of the first turbocharger 60 and/or the second turbocharger 61 is too high, the amount of exhaust gas within the first exhaust gas line 20 and second exhaust gas line 30 may be reduced by opening the wastegate valve 71 so that exhaust gas within the exhaust gas balance tube 65 may be vented or released to reduce the speed of the first turbocharger 60 and second turbocharger 61. In some circumstances, it may be desirable to increase the mass flow through the first turbocharger 60 and the second turbocharger 61 by opening compressor bypass valve 73 and thus permit compressed air to pass from the aftercooler 58 to the exhaust gas balance tube 65.

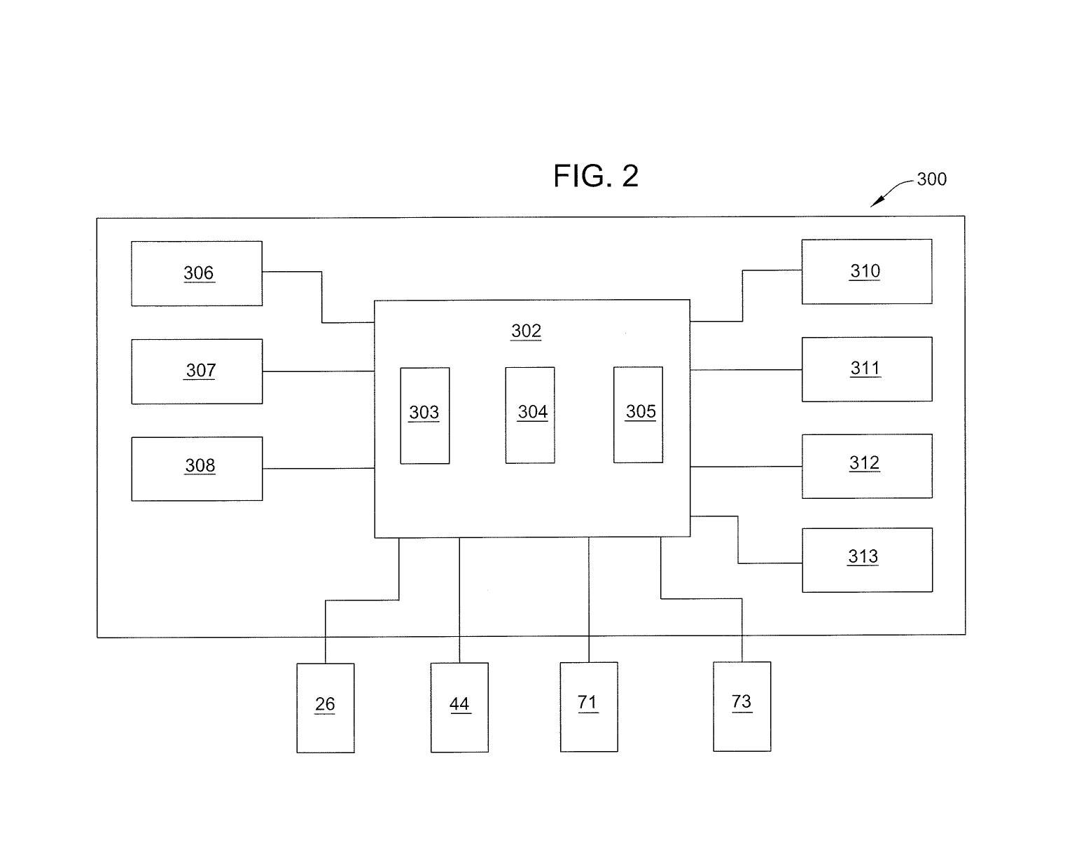

Referring to FIG. 2, operation of the exhaust recirculation valve 26, the exhaust gas recirculation control valve 44, the wastegate valve 71, and the compressor bypass valve 73 may be controlled by a control system 300 having a controller 302. At regular intervals during the operation of the internal combustion engine 10 (e.g., every fifteen milliseconds) as well as at start-up, positioning of and communications with the exhaust restriction valve 26, the exhaust gas recirculation control valve 44, the wastegate valve 71, and the compressor bypass valve 73 may be monitored by controller 302 to ensure proper operation and functionality. A malfunction or fault condition of any of the valves may result in decreased performance, an increase in emissions and/or damage to the internal combustion engine 10. For example, if the exhaust gas recirculation control valve 44 is closed to a greater extent than desired, backpressure within the exhaust gas system 28 may be undesirably high. This may negatively affect performance of the internal combustion engine 10. In a situation in which both the exhaust restriction valve 26 and the exhaust gas recirculation control valve 44 are closed, the resulting blockage within the exhaust system 28 may damage the internal combustion engine or the exhaust system. In another example, if the exhaust restriction valve 26 is closed to a greater extent than desired, operation of the exhaust gas recirculation system 40 may be impaired which may result in an increase in emissions. Accordingly, in case of a malfunction or fault condition, it may be desirable to modify the operation of the internal combustion engine 10 and/or alter the position of one or more of the exhaust restriction valve 26, the exhaust gas recirculation control valve 44, the wastegate valve 71, and the compressor bypass valve 73 to minimize the impact on the internal combustion engine 10 and its performance.

The controller 302 may be configured to monitor various operating parameters and sensors of the exhaust recirculation valve 26, exhaust gas recirculation control valve 44, wastegate valve 71 and compressor bypass valve 73, compare them to respective expected values as well as diagnose malfunctions or fault conditions in the various systems and sensors and determine when monitored parameters, or sets of parameters, diverge from expected values. The controller 302 may include a register of diagnostic codes that correspond to certain malfunctions or fault conditions detected by the controller. In one embodiment, the malfunctions and fault conditions may be related to the operation of each of the exhaust recirculation valve 26, the exhaust gas recirculation control valve 44, the turbocharger wastegate valve 71 and the compressor bypass valve 73. Examples of malfunctions and fault conditions may include a loss of communication failure 310, an unknown valve position failure 311, a limited valve position failure 312 and an actuator failure 313. A loss of communication failure 310 may be indicated if communication between the controller 302 and a particular valve has been lost or if power to the actuator of a valve has been lost. An unknown valve position failure 311 may be indicated if the actuator is unable to locate the open and closed end stop positions of a valve, the range of located end stops is outside a desired specification, or a significant difference exists between a commanded position and an actual position of a valve. A limited valve position failure 312 may be indicated if the default end stop position of the valve is known but the opposite end stop position is unknown. An actuator failure 313 may be indicated if the actuator needs calibration or has been depowered and must be re-powered. Each of the malfunction and fault conditions may represent values that can be selectively changed by one or more control algorithms operating within the controller 302 and whose values may be stored in the controller 302.

One or more data maps relating to the operating conditions of the internal combustion engine 10 may be stored in the memory of controller 302. Each of these maps may include a collection of data in the form of tables, graphs, and/or equations. In one example, a first or exhaust temperature data map 303 relates to the exhaust temperature of the internal combustion engine 10. A second or turbocharger speed data map 304 may relate to the speed of the turbochargers. A third or compressor pressure ratio data map 305 may relate to the pressure increase through the compressor section of one or both of the first turbocharger 60 and the second turbocharger 61. Control or operation of the internal combustion engine 10 may be affected by the controller 302 upon the occurrence of a malfunction or fault condition based upon the data within the maps.

Controller 302 may be an electronic controller that operates in a logical fashion to perform operations, execute control algorithms, store and retrieve data and other desired operations. The controller 302 may include or access memory, secondary storage devices, processors, and any other components for running an application. The memory and secondary storage devices may be in the form of read-only memory (ROM) or random access memory (RAM) or integrated circuitry that is accessible by the controller 302. Various other circuits may be associated with the controller 302 such as power supply circuitry, signal conditioning circuitry, driver circuitry, and other types of circuitry. The controller 302 may be a single controller or may include more than one controller disposed to control various functions and/or features of the internal combustion engine 10 as well as exhaust recirculation valve 26, exhaust gas recirculation control valve 44, wastegate valve 71 and compressor bypass valve 73. In this embodiment, the term “controller” is meant to include one or more controllers that may be associated with the exhaust recirculation valve 26, exhaust gas recirculation control valve 44, wastegate valve 71 and compressor bypass valve 73 and that may cooperate in controlling various functions and operations of the valves. The functionality of the controller 302 may be implemented in hardware and/or software without regard to the functionality.

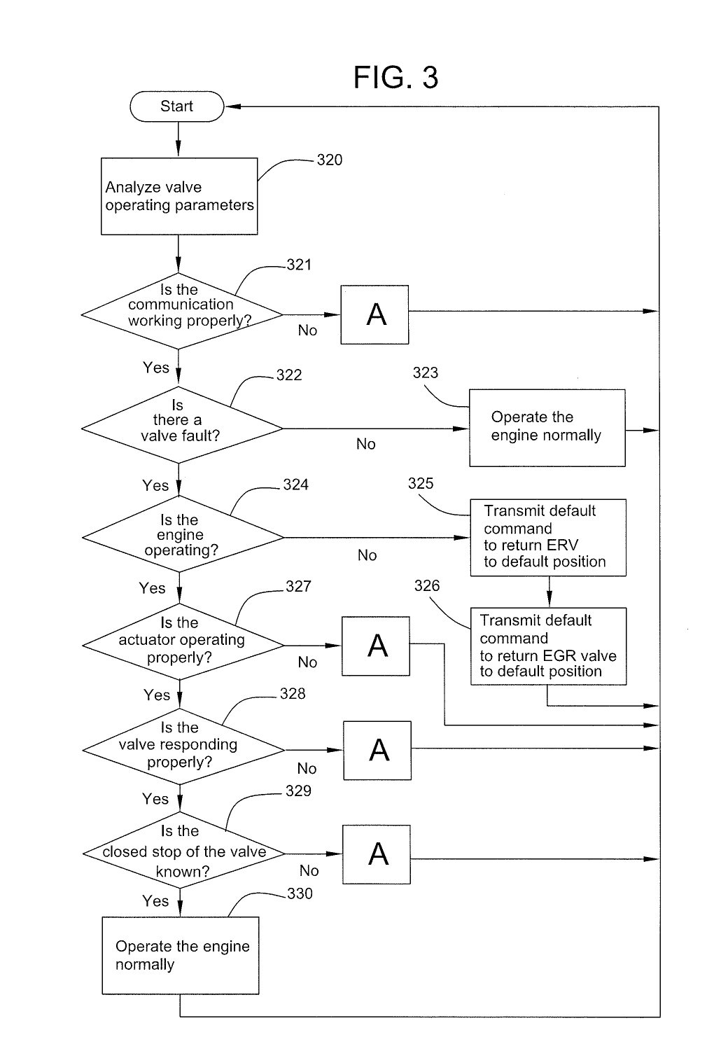

FIG. 3 is a flow chart of a process for responding to malfunctions and fault conditions related to the exhaust gas recirculation control valve 44. Controller 302 is configured to receive an exhaust gas recirculation control valve fault signal indicative of a fault of the exhaust gas recirculation control valve 44 and subsequently transmit an appropriate signal in response to such a fault. The operations described below relative to the flow chart are operations that may be performed by the controller 302 in accordance with appropriate controlled algorithms being executed therein. That is, the disclosed process may be executed by a controller via the execution of computer-executable instructions that are read from a computer-readable medium. While the methodology is described with reference to the controller 302 shown in FIG. 2, the method is applicable to any controller that monitors the operation of a system to diagnose fault conditions in one or more components of the system. Also, while a particular sequence may be shown for convenience, the controller 302 may actually be responding to different malfunctions and fault codes or conditions and without regard to the sequence identified in the flow chart.

The controller 302 analyzes the operating parameters of the exhaust gas recirculation control valve 44 when the control system 300 is powered-up and at regular, fixed intervals (e.g., every fifteen milliseconds) at stage 320. At stage 321, the signals from the exhaust gas recirculation control valve 44 are analyzed to determine if the communication between the exhaust gas recirculation control valve 44 and the controller 302 is working properly. In one embodiment, the communications channel uses a controller area network (CAN) vehicle bus standard but other communications protocols may also be used. If the communication between the exhaust gas recirculation control valve 44 and the controller 302 is not working properly, the specific condition of the exhaust gas recirculation control valve 44 may not be determined by the controller. In such case, the backpressure within the exhaust gas system 28 may be undesirably high which may undesirably affect the performance of the internal combustion engine 10. In a situation in which both the exhaust recirculation valve 26 and the exhaust gas recirculation control valve 44 are closed, damage to the engine may occur. Accordingly, controller 302 may be configured to provide instructions or commands to the internal combustion engine 10 and some or all of the exhaust restriction valve 26, the exhaust gas recirculation control valve 44, the wastegate valve 71, and the compressor bypass valve 73 so that the internal combustion engine and valves are instructed to operate in a desired, predetermined manner that will minimize the likelihood of damage to the internal combustion engine and maintain at least a minimum desired performance level.

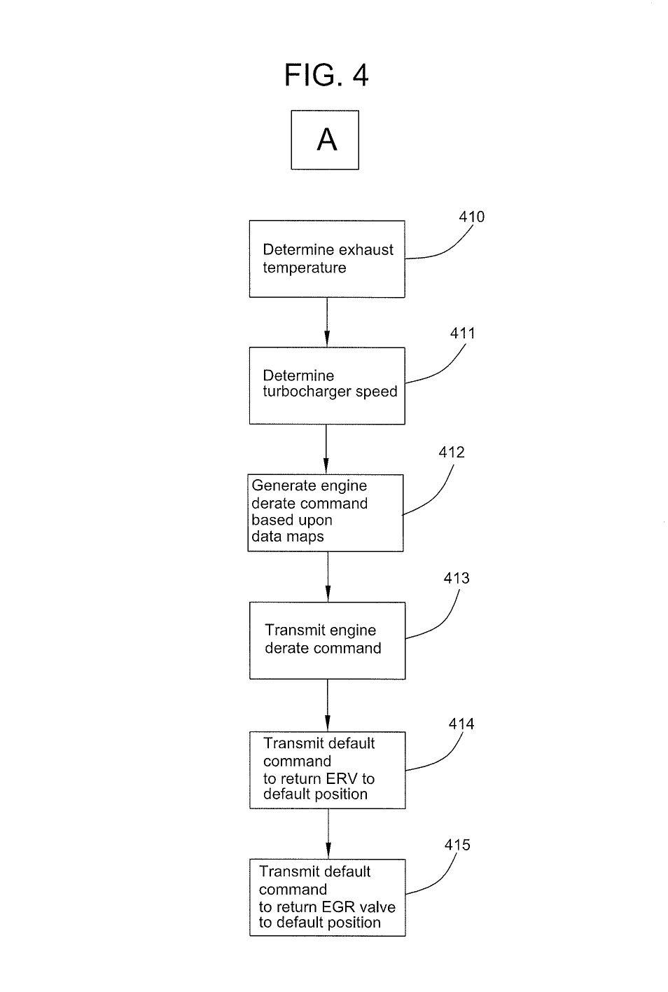

Upon the occurrence of a communications failure at stage 321, the process “A” according to FIG. 4 may be followed. Various operating conditions of the internal combustion engine 10 may be monitored and factored into the controller's instructions based upon the communications failure. More specifically, the exhaust temperature may be determined at stage 410 by measurement through an exhaust temperature sensor 306 that provides an exhaust temperature signal to controller 302 or virtually by monitoring other operating conditions of the internal combustion engine 10. The exhaust temperature sensor 306 may be positioned, for example, adjacent first exhaust manifold 21. Turbocharger speed may be determined at stage 411 by measurement through sensors 307 that provides a turbocharger speed signal to controller 302 or virtually by monitoring other operating conditions of the internal combustion engine 10. The sensors 307 may be positioned at one or both of the first turbocharger 60 and the second turbocharger 61. At stage 412, the controller 302 may determine an exhaust temperature derate factor based upon the exhaust temperature data map 303 together with the exhaust temperature and also determines a turbocharger speed derate factor based up the turbocharger speed data map 304 together with the turbocharger speed. The exhaust temperature derate factor and the turbocharger speed derate factor may be compared to a default or safe mode derate factor and the largest derate factor may be set as the engine derate command. At stage 413, the engine derate command may be transmitted to derate the internal combustion engine 10 such as by controlling the supply of fuel. At stage 414, a default command signal may be transmitted to the exhaust recirculation valve 26 commanding it to return to or towards its default or open position. At stage 415, a default command signal may be transmitted to the exhaust gas recirculation control valve 44 commanding it to return to or towards its default or closed position. More specifically, the exhaust recirculation valve 26 may be commanded to return to or towards its default or open position and the exhaust gas recirculation control valve 44 may be commanded to return to or towards its default or closed position.

If the communication between the controller 302 and the actuator of the valve is working properly at stage 321, the controller monitors the exhaust gas recirculation control valve 44 at stage 322 to determine if there is a malfunction or fault condition with the control of the exhaust gas recirculation control valve. If no malfunction or fault condition is detected, the internal combustion engine 10 operates normally at stage 323 without intervention by the malfunction and fault functionality of controller 302. If a malfunction or fault condition is detected at stage 322, the steps taken by the controller 302 are dependent upon whether the engine is operating as specified at stage 324. If the engine is not operating, the controller 302 may transmit command signals to return the exhaust restriction valve 26 and the exhaust gas recirculation control valve 44 to their default positions. More specifically, the controller 302 may command, at stage 325, the exhaust restriction valve 26 to return to its default or open position and may command, at stage 326, the exhaust gas recirculation control valve 44 to return to its default or closed position.

If the engine is operating and a malfunction or fault condition has been detected by controller 302, the controller may determine, at stage 327, whether the malfunction or fault is the result of an actuator failure. More specifically, the controller 302 determines whether the actuator of the exhaust gas recirculation control valve 44 has been depowered and must be re-powered or requires calibration. If the actuator is not operating properly, the controller 302 may operate in accordance with the process “A” of FIG. 4 as described above. If the actuator of the exhaust gas recirculation control valve 44 is operating properly, the controller 302 may determine, at stage 328, whether the exhaust gas recirculation control valve 44 is responding properly. If the exhaust gas recirculation control valve is not responding properly (e.g., the exhaust gas recirculation control valve is out of calibration), the controller again may operate in accordance with the process “A” of FIG. 4.

If the exhaust gas recirculation control valve 44 is operating properly, the controller 302 may confirm, at stage 329, whether the default position (i.e., the fully closed end stop position) of the exhaust gas recirculation control valve 44 has been found by the controller. If the closed end stop position has not been found, the controller 302 may operate in accordance with the process “A” of FIG. 4. At both of stages 328 and 329, the controller 302 may command the exhaust gas recirculation control valve 44 to continue to attempt to locate either or both of the open and closed end stop positions of the valve. If the closed end stop position of the exhaust gas recirculation control valve 44 is known, the internal combustion engine 10 may operate normally at stage 330 without intervention by the malfunction and fault functionality of controller 302, even if the open end stop position is not known. In such case, an error code may be generated as the internal combustion engine 10 may be operating at reduced performance levels.

As may be understood from the foregoing, one of many different malfunctions or fault conditions with respect to the exhaust gas recirculation control 44 may result in a command to move the exhaust restriction valve 26 to its default or open position and a command to move the exhaust gas recirculation control valve 44 to its default or closed position. If desired, the controller 302 may be configured to command the exhaust restriction valve 26 and or the exhaust gas recirculation control valve 44 to one or more other positions depending on the malfunction or fault condition as well as the operating conditions of the internal combustion engine 10.

Controller 302 is configured to receive an exhaust restriction valve fault signal indicative of a fault of the exhaust restriction valve 26 and subsequently transmit an appropriate signal in response to such a fault. Operation of the controller 302 with respect to malfunctions and fault conditions of the exhaust restriction valve 26 may be identical to that of the exhaust gas recirculation control valve 44 as set forth in FIGS. 3-4 except that the operation of controller 302 at step 328 is modified to determine whether the open end stop position of the exhaust restriction valve 26 is known. Accordingly, the process with respect to the malfunctions and fault conditions of the exhaust restriction valve 26 is not repeated herein. The process of stage 328 of FIG. 3 determines whether the default position of the valve is known, regardless of whether the process of FIG. 3 is being applied to the exhaust restriction valve 26 or the exhaust gas recirculation control valve 44. A malfunction or fault condition of the exhaust restriction valve 26 may result in the poor performance of the internal combustion engine including the generation of additional emissions. As a result, a malfunction or fault condition with respect to the exhaust restriction valve 26 may result in a command to move the exhaust restriction valve 26 to its default or open position and a command to move the exhaust gas recirculation control valve 44 to its default or closed position. If desired, the controller 302 may be configured to command the exhaust restriction valve 26 and or the exhaust gas recirculation control valve 44 to one or more other positions depending on the malfunction or fault condition as well as the operating conditions of the internal combustion engine 10.

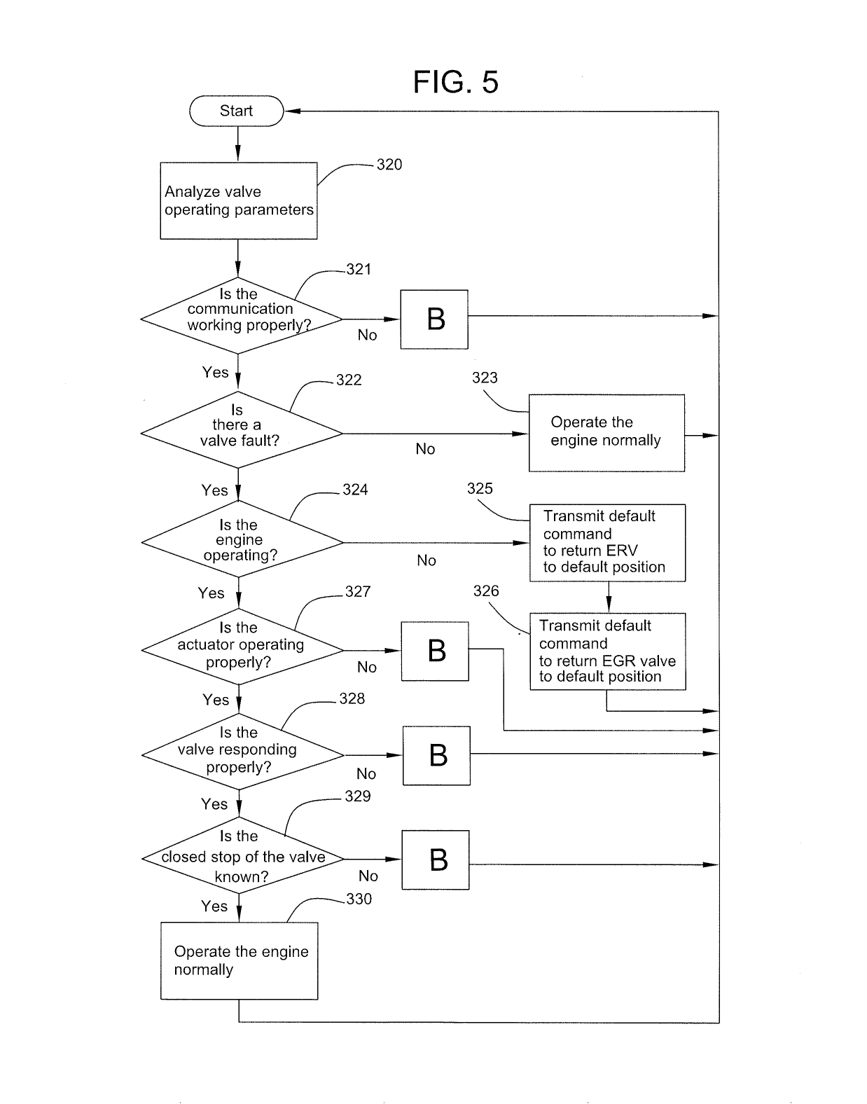

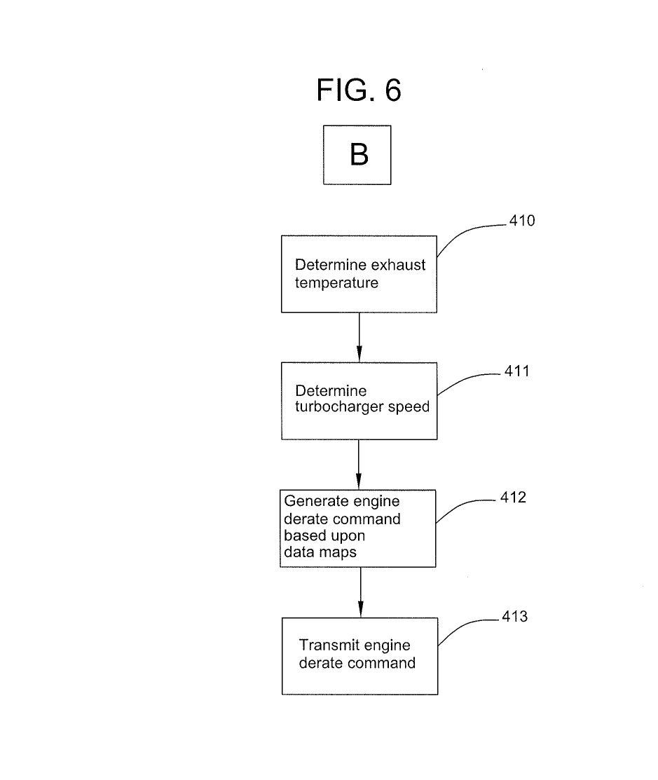

Referring to FIG. 5, a process with respect to malfunctions and fault conditions of the wastegate valve 71 is depicted. Each of the stages 320-329 are identical to those of FIG. 3 and the description of each stage is not repeated herein. However, negative responses at stages 321 and 327-329 cause the controller 302 to operate in accordance with the process “B” of FIG. 6. More specifically, if the communication between controller 302 and wastegate valve 71 is not working properly at stage 321, the actuator of the wastegate valve 71 is not operating properly at stage 327, the wastegate valve 71 is not responding properly at stage 328 or the fully closed end stop position is not known at stage 329, the controller 302 may derate the internal combustion engine 10. The process steps of FIG. 6 are identical to the stages 410-413 of FIG. 4. The controller 302 may determine the exhaust temperature at stage 410, and may determine the turbocharger speed at stage 411. An engine derate command may be generated at stage 412 by controller 302 based upon the largest of the exhaust temperature derate factor, the turbocharger derate factor and the default derate factor. The engine derate command may then be transmitted at stage 413 by controller 302.

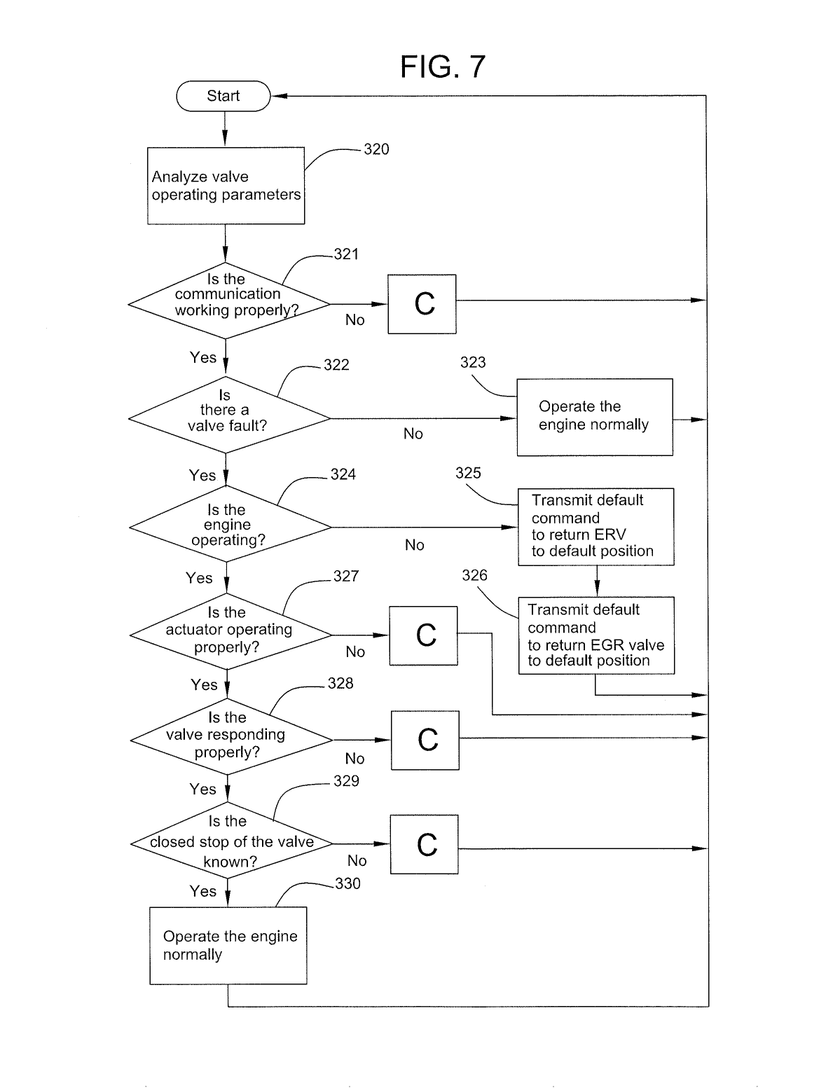

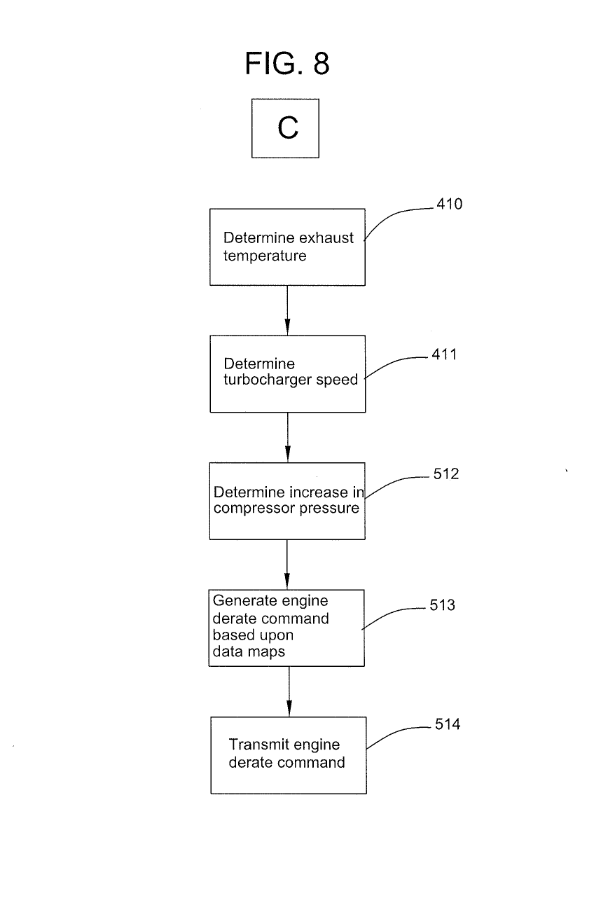

Referring to FIG. 7, a process with respect to malfunctions and fault conditions with respect to the compressor bypass valve 73 is depicted. Each of the stages 320-329 are identical to those of FIG. 5. Negative responses at stages 321 and 327-329 result in the controller 302 operating in accordance with the process “C” of FIG. 8. FIG. 8 is similar to FIG. 6 but includes an additional data point upon which the derate command may be calculated. More specifically, the controller 302 may determine the exhaust temperature at stage 410, and may determine the turbocharger speed at stage 411. At stage 512, the difference in pressure before and after the compressor section of one or both of the first turbocharger 60 and the second turbocharger 61 is determined by sensors 308 and a compressor pressure ratio signal is sent to controller 302. At stage 513, the controller 302 determines an exhaust temperature derate factor based upon the exhaust temperature together with the exhaust temperature data map 303, a turbocharger speed derate factor based upon the turbocharger speed together with the turbocharger speed data map 304, a compressor pressure ratio derate factor based upon the increase in pressure through the compressor section of the turbocharger 60 and the compressor pressure ratio data map 305. All of the derate factors may then be compared against a default or safe mode derate factor. The highest derate factor may be utilized as the derate command signal at stage 512. At stage 513, the derate command signal is transmitted by controller 302. It should be noted that, as can be seen in FIGS. 6 and 8, malfunctions or fault conditions that result in negative responses at stages 321 and 327-329 with respect to the wastegate valve 71 and the compressor bypass valve 73 may not result in controller 302 commanding the exhaust restriction valve 26 and the exhaust gas recirculation control valve 44 to return their default positions.

### INDUSTRIAL APPLICABILITY

The industrial applicability of the system described herein will be readily appreciated from the foregoing discussion. The present disclosure is applicable to internal combustion engines that utilize an exhaust gas recirculation system. In one aspect, in case of a malfunction or fault condition with respect to one of the valves through which exhaust gas flows, a controller 302 may be configured to protect or minimize the likelihood of damage to the internal combustion engine 10. In another aspect, the controller 302 may be configured to maintain at least a minimum desired performance level of the internal combustion engine 10. In still another aspect, the controller may be configured to derate the engine.

The internal combustion engine 10 includes an exhaust restriction valve 26 and an exhaust gas recirculation control valve 44. A controller 302 may be configured to command one of the exhaust restriction valve 26 and the exhaust gas recirculation control valve 44 to move towards a default position of that valve upon the controller 302 determining that a malfunction or fault condition exists with respect to the other of the exhaust restriction valve 26 and the exhaust gas recirculation control valve 44. In addition to or in the alternative, the controller 302 may command the malfunctioning or faulting valve to move towards a default position of that valve. Still further, a malfunction or default condition may result in the internal combustion engine 10 being derated based upon various operating conditions of the engine. The controller 302 may also control the position of one or both of the exhaust restriction valve 26 and the exhaust gas recirculation control valve 44 based upon a malfunction or fault condition of a wastegate valve 71 or a compressor bypass valve 73. The control system 300 includes a controller 302 for coordinating the control of the internal combustion engine 10 as well as some or all of the exhaust restriction valve 26, the exhaust gas recirculation control valve 44, the wastegate valve 71, and the compressor bypass valve 73.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An internal combustion engine comprising:
a plurality of combustion cylinders;
an intake air system for supplying air to the combustion cylinders;
an exhaust gas system fluidly connected to the combustion cylinders, the exhaust gas system including an exhaust manifold, an exhaust gas outlet, and an exhaust restriction valve for controlling flow of exhaust gas from the exhaust manifold to the exhaust gas outlet;
an exhaust gas recirculation system for recirculating exhaust gas from the exhaust gas system to the intake air system, the exhaust gas recirculation system including an exhaust gas recirculation control valve for controlling flow of exhaust gas to the intake air system; and
a controller configured to:
receive an exhaust restriction valve fault signal indicative of a fault of the exhaust restriction valve; and
transmit a signal directing the exhaust gas recirculation control valve to move towards a closed position.

2. The internal combustion engine of claim 1, wherein the controller is configured to determine an engine derate command and transmit the engine derate command to the internal combustion engine.

3. The internal combustion engine of claim 2, wherein the controller is configured to receive a plurality of signals indicative of operating conditions of the internal combustion engine, and the engine derate command is based at least in part on the operating conditions of the internal combustion engine.

4. The internal combustion engine of claim 2, wherein the controller is configured to determine an exhaust temperature of the internal combustion engine and the engine derate command is based at least in part on the exhaust temperature.

5. The internal combustion engine of claim 2, wherein the controller is configured to determine a turbocharger speed of the internal combustion engine and the engine derate command is based at least in part on the turbocharger speed.

6. The internal combustion engine of claim 2, wherein the internal combustion engine has a turbocharger and a compressor bypass valve and the controller is configured to receive a compressor pressure ratio signal indicative of a pressure differential before and after a compressor section of the turbocharger and the engine derate command is based at least in part on the compressor pressure ratio signal.

7. The internal combustion engine of claim 1, wherein the controller is configured to also transmit a signal directing the exhaust restriction valve to move towards an open position in response to the controller receiving the exhaust restriction valve fault signal.

8. The internal combustion engine of claim 1, wherein the controller is configured to also receive an exhaust gas recirculation control valve fault signal indicative of a fault of the exhaust gas recirculation control valve and transmit a signal directing the exhaust restriction valve to move towards an open position and transmit a signal directing the exhaust gas recirculation control valve to move towards a closed position.

9. The internal combustion engine of claim 1, wherein the exhaust gas recirculation control valve is located downstream of an exhaust gas recirculation cooling component.

10. The internal combustion engine of claim 1, wherein the exhaust restriction valve is located upstream of a turbocharger.

11. The internal combustion engine of claim 1, wherein the exhaust restriction valve is located between a first cylinder group of combustion cylinders and a second cylinder group of combustion cylinders.

12. An internal combustion engine comprising:
a plurality of combustion cylinders;
an intake air system for supplying air to the combustion cylinders;
an exhaust gas system fluidly connected to the combustion cylinders, the exhaust gas system including an exhaust manifold, an exhaust gas outlet, and an exhaust restriction valve for controlling flow of exhaust gas from the exhaust manifold to the exhaust gas outlet;
an exhaust gas recirculation system for recirculating exhaust gas from the exhaust gas system to the intake air system, the exhaust gas recirculation system including an exhaust gas recirculation control valve for controlling flow of exhaust gas to the intake air system; and
a controller configured to:
receive an exhaust gas recirculation control valve fault signal indicative of a fault of the exhaust gas recirculation control valve; and
transmit a signal directing the exhaust restriction valve to move towards an open position.

13. The internal combustion engine of claim 12, wherein the controller is configured to determine an engine derate command and transmit the engine derate command to the internal combustion engine.

14. The internal combustion engine of claim 13, wherein the controller is configured to receive a plurality of signals indicative of operating conditions of the internal combustion engine, and the engine derate command is based at least in part on the operating conditions of the internal combustion engine.

15. The internal combustion engine of claim 12, wherein the exhaust gas recirculation control valve is located downstream of an exhaust gas recirculation cooling component.

16. The internal combustion engine of claim 12, wherein the exhaust restriction valve is located upstream of a turbocharger.

17. The internal combustion engine of claim 12, wherein the exhaust restriction valve is located between a first cylinder group of combustion cylinders and a second cylinder group of combustion cylinders.

18. A method of controlling valve positioning in an internal combustion engine having a exhaust restriction valve for selectively restricting engine exhaust exiting from combustion cylinders of the internal combustion engine and an exhaust gas recirculation control valve for restricting an output of an exhaust gas recirculation system of the internal combustion engine, comprising:
receiving a fault signal indicative of a fault of a first valve of the exhaust restriction valve and the exhaust gas recirculation control valve; and
transmitting a signal directing a second valve of the exhaust restriction valve and the exhaust gas recirculation control valve to a predetermined position.

19. The method of claim 18, wherein the predetermined position is a default position of the second valve.

20. The method of claim 19, further including transmitting a signal directing the first valve to its default position.
